(19) United States
(12) Patent Application Publication
(10) Pub. No.: US 2008/0183341 A1
(43) Pub. Date: Jul. 31, 2008

(54) METHOD AND APPARATUS FOR TORQUE CONTROL FOR MACHINERY USING COUNTER-ROTATING DRIVES

(76) Inventors: Wayne L. Neu, Blacksburg, VA (US); John B. Hennage, Blacksburg, VA (US); Daniel J. Stilwell, Blacksburg, VA (US); Ryan K. Williams, Roanoke, VA (US); Jan Petrich, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/843,151

(22) Filed: Aug. 22, 2007

Related U.S. Application Data
(60) Provisional application No. 60/839,138, filed on Aug. 22, 2006.

(51) Int. Cl. G05D 1/08

(52) U.S. Cl. 701/1

(57) ABSTRACT

An active feedback roll stabilization and torque control for a vehicle or equipment, having a propulsion unit with counter-rotating rotary members, detects a vehicle roll or torque, detects an error between the detected roll or torque and a reference roll or torque and, based on the detected error, dynamically and individually controls the respective torque and, hence, reaction torque exerted by the counter-rotating rotary members, to obtain a net reaction torque continually urging the vehicle's roll or torque to move the error toward zero.

### CROSS-REFERENCE TO RELATED APPLICATIONS

This application claims priority to U.S. Provisional Application Ser. No. 60/839,138 filed Aug. 22, 2006, which is hereby incorporated by reference in its entirety.

### FIELD OF THE INVENTION

The embodiments relate generally to torque control and more particularly to stabilization by torque control using counter-rotating drives.

### BACKGROUND OF THE INVENTION

When a water vehicle is propelled through water, hydrodynamic and other forces may cause the vehicle to exhibit one or more unwanted angular movements, generally characterized as roll, pitch and yaw. An example illustration is given at FIG. 1, with block 2 representing any water vehicle. Roll R is angular motion about the longitudinal axis LX of the water vehicle 2, typically extending from front to rear. Pitch P is angular motion about the water vehicle's transverse axis TX, and yaw Y is angular motion about the yaw axis YX, i.e., the axis orthogonal to both the longitudinal axis LX and the transverse axis TX.

Roll R may be particularly problematic with underwater water vehicles, because the roll inertia and the roll resistance of such vehicles are substantially lower than their inertia and resistance to pitch and yaw. This problem has been known prior to the present invention, but its present solutions have particular limitations and shortcomings.

One solution for roll stability is movable fins, positioned and controlled specifically to alter the hydrodynamic forces acting on the hull to induce a counter-roll motion, thereby “righting” the vehicle. However, roll control surfaces present drag and, because roll is typically easily induced, often require robust control methods. Further, hydrodynamic forces may result from roll control fins such that, even if proper to stabilize or correct the roll, often induce a pitch and/or yaw motion, which must then be counteracted.

Another solution for roll stability is to construct and arrange the underwater vehicle with a distribution of weight and displacement such that gravitation pull always urges the vehicle to a given roll angle, typically zero. Typically the arrangement is such that the center of weight is below the center of buoyancy, i.e., such that the “bottom” is heavier than the “top.” Gravity always urges the center of weight and center of buoyancy into vertical alignment. If roll is induced, gravity imparts a restore torque, urging the vehicle back to the upright position. This is termed “passive roll stabilization.”

Passive roll stabilization, though, has limitations. One limitation is that requiring the center of weight to be below the center of buoyancy necessarily imposes constraints in the location of mass within the vehicle. Another is that, due to physical constraints of mass distribution, the maximum attainable stabilizing effect is limited. Another limitation is that the restorative force is inherently proportional to the roll, approaching zero at zero roll. As a result, roll oscillation about the zero roll may occur.

### SUMMARY OF THE INVENTION

An active feedback stabilization for a vehicle in a medium is disclosed that controls angular orientation of the vehicle and net torque by dynamically controlling the net reactive torque exerted on the vehicle by a plurality of rotating and counter-rotating acting members extending from the vehicle and rotating within the medium, to produce a dynamic correcting torque, having a magnitude and direction controlling the angular orientation. An active feedback stabilization is disclosed, in which a vehicle angular orientation is measured, an error is detected between the measured orientation and a reference orientation and, based on the detected error, the respective torque applied by the vehicle to each of the rotating and counter-rotating members is individually and automatically controlled, to vary the direction and magnitude of the net reaction torque to rotate the vehicle counter to detected error, thereby dynamically reducing the error toward zero.

For underwater vehicle and other applications, the disclosed active stabilization through dynamic torque control enables construction and operation classes of vehicles that may otherwise be infeasible.

### BRIEF DESCRIPTION OF THE DRAWINGS

FIG. 1 is a diagram of an example reference system for pitch, roll and yaw of a body;

FIG. 2 is a schematic example according to one embodiment, having a vehicle with feedback control of roll by dynamic controlling of the net torque delivered by the vehicle's plurality of counter-rotating drive members based on sensed roll;

FIG. 3 shows a roll versus time test data observed for a prototype constructed according to FIG. 2; and

FIG. 4 shows a roll versus time test data of the prototype of FIG. 3 without feedback control of the plurality of counter-rotating drive members.

### DETAILED DESCRIPTION OF ILLUSTRATIVE EMBODIMENTS

The following detailed description of the invention is in reference to accompanying drawings, which form a part of this description. The drawings are illustrative examples of various embodiments and combinations of embodiments in which the invention may be practiced. The invention is not limited, however, to the specific examples described herein and/or depicted by the attached drawings. Other configurations and arrangements can, upon reading this description, be readily seen and implemented by persons skilled in the arts.

In the drawings, like numerals appearing in different drawings, either of the same or different embodiments of the invention, reference functional or system blocks that are, or may be, identical or substantially identical between the different drawings.

Various embodiments of the invention, although different, are not necessarily mutually exclusive. For example, a feature described in or in relation to one embodiment may, within the scope of the invention, be included in or used with other embodiments. Various instances of the phrase “in one embodiment” do not necessarily refer to the same embodiment.

Unless otherwise stated or made clear from its context, terminology and labeling used herein is not limiting and, instead, is only for purposes of consistency referencing illustrative examples.

Embodiments and examples are described sufficient for a person of ordinary skill in the art pertaining to water vehicle roll stabilization to practice the invention. The description therefore assumes the reader possesses a general knowledge of the basics and conventional design practices of propellers, propeller drives, feedback control, programming and use of micro-controllers, selecting and using relevant water vehicle power units and roll sensors. Therefore, except for illustrative examples, basic knowledge that a person of ordinary skill would, upon reading this disclosure, utilize in practicing the invention is omitted, or not described in detail.

Unless otherwise stated or clear from the description, exploded views in the drawings are only for illustrating spatial relations, and are not limiting as to any order of steps in fabricating or assembling any structures.

Unless otherwise stated or clear from their context in the description, various instances of the terms “arranged on” and “provided on” mean only a spatial relationship of structure(s) and, unless otherwise stated or made clear from the context, do not limit any sequence or order of fabrication.

### General Overview

Examples are described in terms “vehicles,” but unless otherwise stated or clear from its context, the term “vehicle” means any structure having an angular orientation rotatable about one or more axes of a fixed reference system, wherein the structure may have a mean centroid location that is substantially stationary and/or is substantially movable along one, two or three dimensions of a three-dimensional space. Illustrative examples of “vehicle” are, without limitation, a boat, a ship, a tethered surface buoy, a tethered submersible buoy, a non-tethered surface buoy, a non-tethered submersible buoy, a submarine, a torpedo, a tethered lighter-than-air balloon, a non-tethered lighter-than-air balloon, lighter-than-air aircraft and a heavier-than-air aircraft.

Examples may be described in terms of “roll” but, unless otherwise stated or clear from its context, “roll” is not limited to the conventional meaning of “roll” in its context of “roll”, “pitch” and “yaw.” Instead, unless otherwise stated or clear from its context, the term “roll” means an angular orientation of a vehicle (or error in angular orientation) along an axis parallel to or substantially parallel to the net reactive torque exerted on the vehicle by rotating and counter-rotating members arranged and controlled in accordance with the described embodiments.

Accordingly, as will be understood from this disclosure in its entirety, arrangements of rotating and counter-rotating members according to the described embodiments may, depending on axis of rotation of the rotating and counter-rotating members, control “roll” with “roll” being within the conventional meaning of any of “roll”, “pitch” and “yaw.”

An embodiment relates to a vehicle having a feedback control roll stabilizer system including a roll sensor and a controller arranged to generate a torque control signal based, at least in part, on a roll difference between the sensed roll and a reference roll, and having a vehicle drive unit that propels the vehicle in a direction of travel while applying a controllable net reactive torque moment on the vehicle, the net reactive torque moment controlled to have a direction that reduces the roll difference.

An embodiment relates to a vehicle having a feedback control stabilizer system including a roll sensor and a controller arranged to generate a torque control signal based, at least in part, on a difference between the sensed roll and a reference roll, a plurality of rotating and counter-rotating members extending from the vehicle to rotate and counter-rotate within a medium, a power unit that, based on the torque control signal, applies an individually controllable torque to individual ones of the plurality of rotating and counter-rotating members, such that the net reactive torque moment on the vehicle from the plurality of rotating and counter-rotating members is controlled to urge a roll motion of the vehicle that reduces the difference.

An embodiment relates to a body having a plurality of rotating members each applying a torque force to a medium, having a feedback control stabilizer system including a reactive torque sensor detecting a net reactive torque acting on the body, and a controller arranged to generate a torque control signal based, at least in part, on the detected net reactive torque, and having a rotating member drive unit that individually rotates the rotating members at respectively different torques, in at least two respectively opposite rotating directions, to reduce the net reactive torque toward zero.

An embodiment includes a feedback control roll stabilizer system for a water vehicle, having a roll sensor and a controller arranged to generate a torque control signal based, at least in part, on a roll difference between the sensed roll and a reference roll, and having a vehicle drive unit that propels the vehicle in a direction of travel while applying a controllable net reactive torque moment on the vehicle, having a direction and magnitude controlled by the torque control signal to rotate the vehicle to reduce the roll difference.

An embodiment includes a vehicle having a roll sensor connected to a controller, the controller connected to two independently controllable mechanical power units, which respectively rotate two counter-rotating members extending from the vehicle into the surrounding medium, effecting two reactive torque moments on the vehicle wherein, based on the roll sensor, controller independently controls the two mechanical power units controls such that the net reactive torque moment is opposite to, and counters the roll detected by the roll sensor.

An example includes two counter-rotating members extending from the vehicle arranged such that rotating one of the rotating members in a first rotation direction produces a first propelling force between the vehicle and the water, urging the water vehicle in a direction of travel, and exerts a first reactive torque on the vehicle. Rotating the other of the counter-rotating members in a rotation direction opposite the first rotation direction produces a second propelling force, having the same or substantially the same direction as the first propelling force, and exerts a second reactive torque moment on the vehicle.

According to a disclosed example, the direction of the second torque moment is opposite, or has a vector component opposite to, the first reactive torque moment, and the vector sum of the first reactive torque moment and the second reactive torque moment is the net reactive torque moment acting on the vehicle.

A disclosed example having two counter-rotating members is only for purposes of an illustrative example, selected for purposes of illustrating typical kinds of parameters and fundamental principles of operation. One alternative example may employ, for example, four counter-rotating members. According to one alternative example, four counter-rotating members may be arranged, for example, such that two rotate in a first direction and two rotate opposite the first direction. Such an example may employ four individually controllable mechanical power units, one for each of the four counter-rotating members. In such an example, the net reactive torque moment is the vector sum of the first, second, third and fourth reactive torque moments.

Another alternative example is a first number of rotating members rotating in a first direction that is not equal to a second number of rotating members rotating in a direction opposite the first direction. One example according to this alternative example is two rotating members rotating in a first direction, and only one rotating member rotating opposite the first direction. One example implementation according to this one example may configure the two rotating members rotating in the first direction to exhibit a first characteristic of fluid dynamics when rotated, and the one rotating member rotating opposite the first direction to exhibit a second characteristic of fluid dynamics, different than the first characteristic. According to one example, four individually controllable mechanical power units rotate the four counter-rotating members, and are controlled in a feedback manner based on a roll sensor such that the net torque, obtained by individually controlling the torque applied to each of the two rotating members rotating in the first direction, as compared to the torque applied to the one rotating member rotating opposite the first rotating direction, such the vector sum of the first and second reactive torque, each having a first direction, and the third reactive torque, having a direction opposite the first direction, is a desired value, such as zero.

A disclosed example having four counter-rotating members is only for purposes of an illustrative example, selected for purposes of illustrating typical kinds of parameters and fundamental principles of operation. One alternative example may employ, for example, six counter-rotating members.

Further to a disclosed example having two counter-rotating members, the controller, based on comparing the vehicle roll detected by the roll sensor to a reference roll, controls the independently controllable mechanical power units to control the ratio of a first torque applied to the first counter-rotating member to the second torque applied to the second counter-rotating member to attain a net reactive torque moment sufficient to maintain the roll angle of the water vehicle within a given error of a desired or nominal roll angle.

A disclosed embodiment includes a vehicle's counter-rotating members arranged coaxial with one another.

A disclosed embodiment includes a vehicle's counter-rotating members arranged not coaxial with one another.

A disclosed embodiment includes a vehicle's counter-rotating members arranged such that the first reactive torque moment and the second reactive torque are parallel, or substantially parallel, to one another.

A disclosed embodiment includes a vehicle's counter-rotating members arranged such that the first reactive torque moment and the second reactive torque moment are parallel, or substantially parallel, to the roll axis of the vehicle.

A disclosed embodiment includes vehicle counter-rotating members arranged such that the first reactive torque moment and the second reactive torque moment have components not parallel to one another or to a conventional roll axis of the vehicle, such that one or both of the first reactive torque moment and the second reactive torque moment may apply, within the conventional meaning of “yaw” and “pitch”, a yaw moment or a pitch moment to the vehicle, and may include controlling or compensating such yaw moment or pitch moment by, for example, combining the counter-rotating rotating members with conventional methods of yaw and pitch correction.

A disclosed embodiment includes a vehicle having a feedback control roll system including a roll sensor and a controller arranged to generate a torque control signal based, at least in part, on a difference between the sensed roll and a reference roll, and that maintains the vehicle in a hover or equivalent state, by applying an individually controllable torque to each of a plurality of counter-rotating members having axis of rotation parallel or substantially parallel to a roll axis, such that a net reactive torque moment on the vehicle induces a given, controllable roll velocity to the vehicle.

A disclosed embodiment includes a vehicle having a feedback control roll system including a roll sensor and a controller arranged to generate a torque control signal based, at least in part, on a difference between the sensed roll and a reference roll, and having a vehicle drive unit that propels the vehicle in a given direction, while concurrently applying a net reactive torque moment on the vehicle that induces a given, controllable roll velocity to the vehicle.

Examples Applying Embodiments

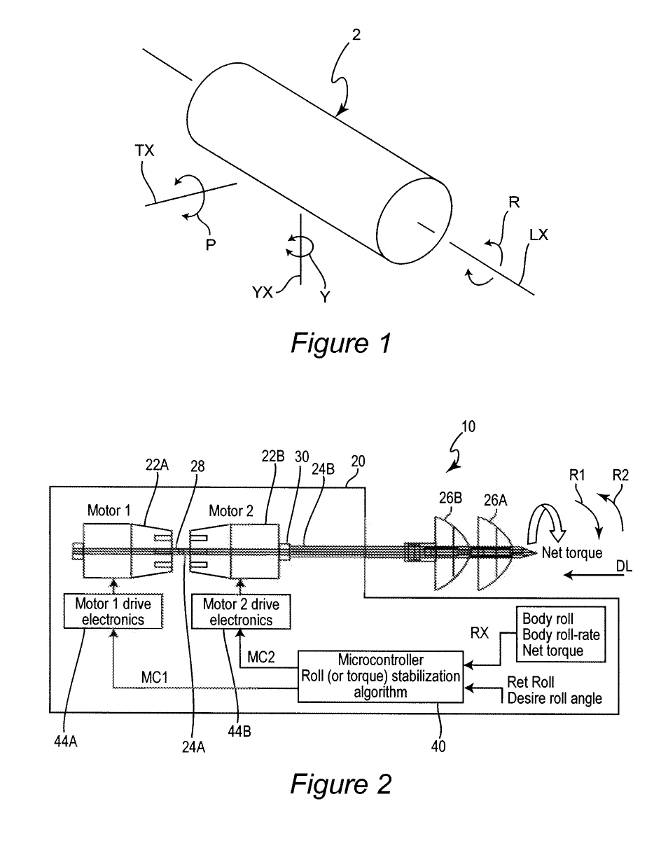

FIG. 2 represents, in schematic form, an example feedback torque control roll stabilization system 10 relating to a water vehicle 20. The water vehicle 20 may be an underwater vehicle, may be capable of surface operation, and may have conventional ballast structures and methods (not shown). Example operations are described in reference to a “vehicle roll axis RL” of vehicle 20, which may be the roll axis LX shown in FIG. 1.

Referring to the FIG. 2 example, the water vehicle 20 may include a first motor 22A and a second motor 22B. The first motor 22A and second motor 22B may be conventional electric motors for underwater vehicles, connected to conventional batteries (not shown). First motor 22A may connect or couple to a first driveshaft 24A connected or coupled to a first propeller 26A. Second motor 22B may connect or couple to a second driveshaft 24B connected or coupled to a second propeller 26B. The first motor 22A and second motor 22B are examples. An embodiment may have more than two motors.

With continuing reference to FIG. 2, first propeller 26A and second propeller 26B are of opposite blade pitch, meaning that first propeller 26A produces thrust force in the DL direction when rotated in direction R1, and second propeller 26B produces thrust force in, or substantially in the DL direction when rotated in direction R2, where R2 is opposite R1. First propeller 26A and second propeller 26B may be arranged coaxially with their rotational axes (not labeled) substantially aligned on a common axis. In the FIG. 2 example arrangement first propeller 26A is upstream of propeller 26B, but this is only for purposes of example.

The coaxial arrangement of the first propeller 26A and the second propeller 26B is an example, and is not a limitation. Counter-rotating propellers may, for example, be arranged with parallel, or substantially parallel axes of rotation, spaced vertically above and below one another or spaced laterally (in the yaw plane) from one another, for example symmetrically about the roll axis RL of the vehicle 20.

Referring to FIG. 2, an arrangement of coaxial propellers 26A and 26B may be driven by constructing and arranging the first drive shaft 24A and second drive shaft 24B coaxial with one another. Referring to FIG. 2, one example coaxial arrangement, described in greater detail below, is the second drive shaft 24B having an outer hollow section (not separately labeled) through which a portion (not separately labeled) of the first drive shaft 24A extends.

Referring to the FIG. 2 example 10, in the example coaxial arrangement of first drive shaft 24A and second drive shaft 24B, drive shafts 24A 24B and propellers 26A 26B may be driven by arranging motors 22A and 22B coaxially with drive shafts 24A 24B. In the FIG. 2 specific example 10, a first motor coupling structure 28 connects first motor 22A to the proximal end of first drive shaft 24A, and a second propeller coupling structure 30 connects the distal end of first drive shaft 24A to first propeller 26A. Similarly, a second motor coupling structure 32 connects second motor 22B to the proximal end of second drive shaft 24B, and a second propeller coupling structure 34 connects the distal end of second drive shaft 24B to second propeller 26B.

The FIG. 2 depicted arrangement for driving a coaxially arranged first propeller 26A and second propeller 26B is only for purposes of example. Alternative structures are apparent to persons skilled in the art, in view of this disclosure. One alternative arrangement (not illustrated) may arrange one or both of the first motor 22A and the second motor 22B with a rotational axis not coaxial with the first and second drive shafts 24A and 24B, and may couple the first motor 22A to the first drive shaft 24A, and/or may couple the second motor 22B to the second drive shaft 24B by, for example, arrangements of bevel gears (not shown) or equivalents.

Referring to FIG. 2, in the example 10 the first motor 22A and second motor 22B are each secured by, for example, mounting bolts (not shown) to the vehicle 20.

With continuing reference to the FIG. 2 example 10, torque controller 40 generates a first motor control signal MC1 and generates a second motor control signal MC2 based, at least in part, on data from the vehicle roll sensors 42, as described in further detail below.

The first motor control signal MC1 may connect to a first motor drive electronics unit 44A, to control electric currents (not shown) through the first motor 22A such that 22A applies a first torque, in the R1 direction, arbitrarily referenced as TQ1, to the first drive shaft 24A, where TQ1 has a magnitude corresponding to the value of MC1. Likewise, the second motor control signal MC2 may connect to a second motor drive electronics unit 44B to control electric currents (not shown) through the second motor 22B such that 22B applies a second torque, in the R2 direction opposite to R1, arbitrarily referenced as TQ2, to the second drive shaft 24B, where TQ2 has a magnitude different from TQ1, corresponding to the value of MC2.

Further, the torques TQ1 and TQ2 may be directly measured by, for example, strain gauges (not shown) or equivalent, detecting rotational strain of the first drive shaft 24A and of the second drive shaft 24B, and/or detecting a compression (or tension) of structures (not shown) securing the first motor 22A and second motor 22B to the vehicle 20. Since the net torque is generally the variable of interest, the individual measured torques may be input to a simple subtraction circuit (not shown) or equivalent, and the difference value (not shown) generated as a net direct torque measurement. The net direct torque measurement may be fed back to the controller 40, and used in the algorithm calculating MC1 and MC2.

Referring to the FIG. 2 example 10, the first torque TQ1 rotating the first propeller 26A in the direction R1 results in two forces: a thrusting force propelling the vehicle 20 in the direction DL, and a first reactive torque equal and opposite TQ1. The first reactive torque is transferred to the vehicle 20 through the mounting bolts (not shown) or other structure securing the first motor 22A to the vehicle. The second torque TQ2 rotating the second propeller 26B in the direction R2 (which is opposite to R1), results in two forces: another thrusting force propelling the vehicle 20 in the direction DL, and a second reactive torque, equal and opposite to TQ2. As will be understood from the entirety of this disclosure, the first torque and second torque TQ1 and TQ2, and their respective opposite first and second reactive torques, are equal to one another only when the vehicle 20 is in the desired (e.g., reference) orientation (e.g., roll), and the desired orientation is the natural orientation of the vehicle, where “natural orientation” means the orientation to which the vehicle tends absent external forces. The second reactive torque is transferred to the vehicle 20 through the mounting bolts (not shown) or other structure securing the second motor 22B to the vehicle.

With continuing reference to FIG. 2, because the first propeller 26A and second propeller 26B are counter-rotating, the first reactive torque and the second reactive torque are opposite in direction. The difference in magnitude between the first reactive torque and the second reactive torque is a net reactive torque, labeled NetTorque, which urges a rotation of the vehicle 20. The projection of the NetTorque moment onto the vehicle roll axis RL rotates the vehicle 20 about the axis RL, in a rotational direction determined by the arithmetic sign of the NetTorque.

The torque controller 40 controls the NetTorque to a desired value by generating the first motor control signal MC1 and the second motor control signal MC2 to apply a first torque TQ1 and a second torque TQ2 (having opposite direction to TQ1), respectively, such that their difference, TQ1−TQ2, equals the NetTorque.

The torque controller 40 preferably generates the first motor control signal MC1 and the second motor control signal MC2 by feedback control based on the detected roll RX such that TQ1−TQ2 controls the NetTorque to maintain the roll RX at a desired value, which may be arbitrarily referenced as RefRoll. The controller 40 may perform the feedback by comparing the measurement RX to RefRoll to obtain a difference, arbitrarily labeled RollError and, based on RollError and a model of roll characteristics of the vehicle 20, generating MC1 and MC2 to produce first torque TQ1 and second torque TQ2 such that NetTorque rotates the vehicle 20 to maintain RollError within a predetermined range. Illustrative examples are, without limitation, a proportional controller, a proportional-derivative controller, or a proportional-integral-derivative controller. Identification of the parameters (not separately labeled) for the feedback control algorithm is readily performed by a person of ordinary skill in the art upon reading the entirety of this disclosure, and include, as illustrative examples, without limitation: dimensions, mass and other characteristics of the propellers 26A and 26B, the performance of the motors 22A and 22B, and a roll damping factor (not labeled) based on, in part, the surface area of the water vehicle, the mass and mass distribution of the water vehicle, and the hull shape of the water vehicle.

Controller 40 may be a microprocessor implementation of a feedback control system, using any of a plurality of conventional feedback control algorithms known in the general art.

Referring to the FIG. 2 example 10, the depicted roll sensor 42 detects roll and generates a data RX. The sensor 42 may further include a roll-rate sensor, and example 10 may also include a torque sensor (such as, for example, disposing a strain gauge on the drive shafts 24A and 24B), and to compute time-varying motor speed commands such as MC1 and MC2 for each motor 22A and 22B.

The feedback control system implemented by the FIG. 2 example 10 to actively and individually controls the rotational speed of the first motor 22A and second motor 22B to automatically adjust the NetTorque on the vehicle 20 to impart the necessary zero or non-zero desired dynamic torque for stabilizing roll, or in some cases to stabilize torque. The resulting affect is that motor speeds are adjusted dynamically to impart the desired torque on the body to stabilize roll.

Referring to the FIG. 2 example 10, the first propeller 26A and second propeller 26B may be aligned on a common axis of rotation, parallel to the roll axis RL of the vehicle 20. The NetTorque moment is then parallel to the roll axis RL. Further, the first propeller 26A and the second propeller 26B may be aligned such that the NetTorque moment is coaxial with the roll axis RL. These are only example arrangements. Embodiments may have axes of rotation of the first propeller 26A and/or second propeller 26B not coaxial with, and/or not parallel with the vehicle roll axis RL. Such embodiments may be include, for example, programming the torque controller to generate MC1 and MC2 such that TQ1 and TQ2 generate a NetTorque that accounts for alignment and orientation of the NetTorque moment to the vehicle roll axis RL.

An embodiment may control torque and roll of a vehicle such as vehicle 20 by a plurality of independently controlled torques applied to independent counter-rotating propellers, such as a first torque TQ1 and a second torque TQ2 applied to propellers 26A and 26B, where the opposite direction torques have unequal magnitude, even if the drive motors, such as the first motor 22A and the second motor 22B, are rotating at equal speed. Unequal torque, such as TQ1 not equal TQ2, may occur, for example, if a first propeller such as 26A and a second propeller such as 26B are selected from propellers not designed to be a counter-rotating pair.

An embodiment having feedback as provided by the torque controller 40, comparing vehicle roll from a roll sensor to a reference roll, and controlling opposite direction torques such as TQ1 and TQ2 to counter-rotating propellers such as 26A and 26B, provides roll control in changing conditions and even using poorly matched counter-rotating propellers. An embodiment provides such roll stability because its feedback controls the different torques TQ1 and TQ2 such that the net reactive torque, e.g., NetTorque, forces the vehicle to the desired roll angle, regardless of changing and differing propeller characteristics.

An embodiment having roll stabilization with feedback torque control of counter-rotating propellers, such as the example 10 of FIG. 2, controls vehicle roll by controlling the torque of the propellers of the vehicle, without control surfaces, without producing lift or drag forces generated as a natural consequence of control surfaces.

An embodiment having the invention's roll stabilization with feedback torque control of counter-rotating propellers, and further having a coaxial arrangement of its counter-rotating propellers provides substantial overall propulsion efficiency improvement over the prior art. Propellers of the prior art typically impart a swirl velocity to their slipstream. Any such swirl velocity represents an energy loss to the system. The embodiments having the invention's roll stabilization with feedback torque control of counter-rotating propeller substantially eliminate this energy loss because, at substantially all time the vehicle is maintained at a stable roll, the motors produce zero net torque, minimizing the swirl velocity ordinarily imparted to the slipstream of a propeller, or propeller combination such as 26A and 26B.

The FIG. 2 example 10 is described above in reference to water vehicle 20 being propelled in a DL direction, but this is only one example. An embodiment is a water vehicle (not shown) denser than water, having a plurality of motors driving a plurality of counter-rotating propellers with the propellers oriented to provide a lift force, to maintain the vehicle in a hover. In this orientation, the vehicle has no preference as to which azimuthal direction it faces. By using a control system to finely adjust the rotational speeds of the motors based on feedback from an orientation sensor, the vehicle can be caused to rotate to point in any commanded direction. The control system is able to hold the vehicle pointed in the commanded direction despite significant time varying external disturbances.

Another embodiment is a feedback torque control of a body, such as a buoy, (not shown) floating at the surface of the water with a plurality of counter-rotating propellers hanging below. For example, a buoy may be rotated to point an antenna (not shown) or camera (not shown) in a desired direction or to rotate and hold a surface vessel in a preferred orientation in the presence of wind, current and wave forces. Referring to FIG. 1, the orientation of such a buoy may be viewed as a “yaw” orientation, instead of a “roll” orientation. Referring to FIG. 2, a feedback control of the multiple motors driving the multiple counter-rotating propellers of such a buoy may be similar to the feedback generation of MC1 and MC2 depicted in FIG. 2, substituting a sensor (not shown) detecting the orientation of the antenna or camera for the roll sensor 42. Further, since the buoy floats on the surface, the counter-rotating “propellers” need not cause a net axial (vertical in this case) force on the floating buoy body.

The FIG. 2 example embodiment shows multiple motors, e.g., motors 22A and 22B, to rotate the propellers 26A and 26B with independent torques TQ1 and TQ2. One alternative embodiment arranges a single motor (not shown) driving two or more counter-rotating propellers, such as propellers 26A and 26B, through (not shown) having an input coupled (not shown) to the motor, a first output (not shown) coupled to the first propeller 26A and a second output (not shown) coupled to the second propeller 26B, wherein the continuously-variable single-input-dual-output transmission is constructed and arranged to rotate the propeller 26A in the first rotating direction, at the first torque TQ1, and to concurrently rotate the second propeller 26B in the second rotating direction opposite the first rotating direction, at the second torque TQ2, where TQ1 and TQ2 are independently controllable based on the RollError data, as described above. The continuously-variable single-input-dual-output transmission (not shown) and the independent control of TQ1 and TQ2 may be in accordance with conventional methods of continuously variable transmissions, combined with the present disclosure.

An embodiment also relates to a body, such as a mixer, having a plurality of rotating members, such as rotary mixing blades each applying a torque force to a medium, such as liquid concrete, having a feedback control stabilizer system including a reactive torque sensor detecting a net reactive torque acting on the body, and a controller arranged to generate a torque control signal based, at least in part, on the detected net reactive torque. A rotating member drive unit may, for example, be a plurality of motors, each individually rotating one of the rotating members, the motors controlled based on the torque control signal to rotate the members at respectively different torques, in at least two respectively opposite rotating directions, to reduce the net reactive torque toward zero.

### Test Observation of Constructed Samples

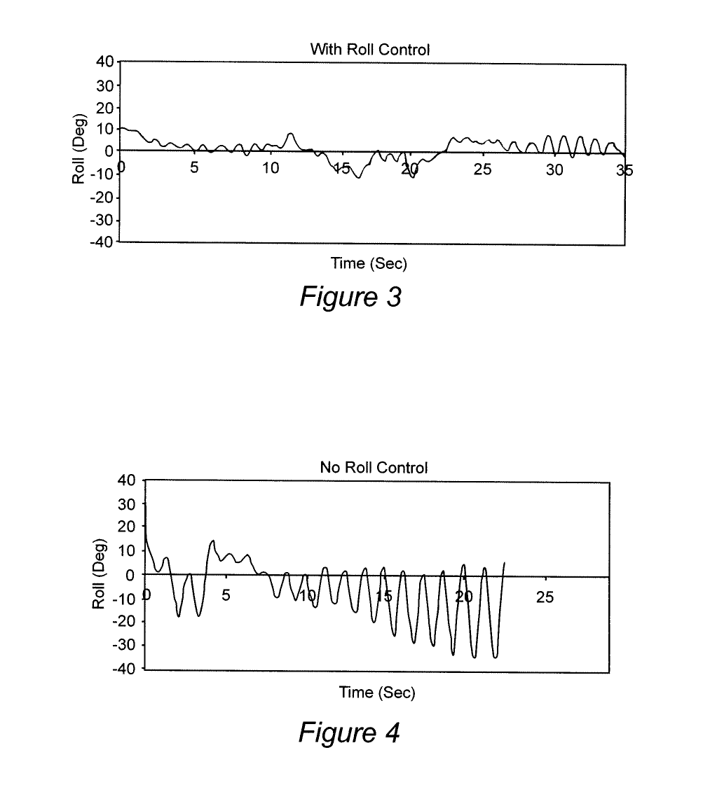

FIG. 3 is a graphical plot of observed roll versus time data, from a constructed high speed autonomous underwater vehicle (HSAUV) prototype embodying a disclosed feedback torque and roll control, having two motors arranged according to the FIG. 2 examples 22A and 22B, driving two counter-rotating propellers, arranged coaxially and driven by coaxial drive shafts, arranged generally such as the example first and second drive shafts 24A and 24B driving the first and second counter-rotating propellers 26A and 26B.

The dimensions and specification of the constructed example (HSAUV) prototype are provided herein for purposes of assisting persons of ordinary skill in the art in fully understanding the test data shown in FIGS. 3 and 4. These dimensions and specifications are only illustrative of one example construction of one system within the meaning of one or appended claims and embodiments, and are not any limitation as to implementations, structures or systems within the meaning of the appended claims. The dimensions and specification of the constructed example (HSAUV) prototype are: Length: approximately 36 inches; Width: approximately 3 inches; Weight: approximately 11.3 lbs; displacement: approximately 7.8 lbs.

The constructed HSAUV prototype used Hyperion™ model Z3025-10 motors, available from, for example, Aircraft World, 24-10 Tokuzen Iizuka, Fukuoka 820-0033 JAPAN. The constructed HSAUV prototype used Castle Creations™, model Barracuda 80 motor controllers, available from Castle Creations, Inc., 235 South Kansas Avenue, Olathe, Kans. 66061, and used a Microstrain™ model 3DM-GX1 roll sensor, available from MicroStrain, Inc., 310 Hurricane Lane, Suite 4, Williston, Vt. 05495 USA. This specific model 3DM-GX1 sensor included roll-rate, pitch, pitch-rate, yaw, and yaw-rate. The constructed HSAUV prototype included a Kontron™ XBoard, available from Diamond Point International (Europe) Ltd., Suites 10 & 13, Ashford House, Beaufort Court, Sir Thomas Longley Road, Rochester, Kent ME2 4FA, England, which is a PC-compatible microprocessor module, running a LINUX operating system, with the control application software in C++, generating motor control signals such as MC1 and MC2 for the motors based on roll signals from the roll sensor.

The HSAUV prototype, due to its dimensions, shape and weight/displacement distribution, had very low resistance to roll. Even a small net torque from the counter-rotating propellers would result in substantial body roll.

Referring to FIG. 3, the roll versus time data shows the HSAUV prototype having a disclosed embodiment of feedback torque/roll control launched from rest, and quickly attaining a steady speed of about 10 knots, and then maintaining roll within ten degrees over approximately 35 seconds. In view of the HSAUV prototype low resistance to roll, and the total propeller force required to move the HSAUV at 10 knots, the FIG. 3 roll data shows significant improvement over prior art counter-rotating propellers, which is shown in FIG. 4.

FIG. 4 shows the prototype HSAUV without the feedback roll/torque control system. The propeller speeds were set relative to one another to produce as little net torque on the body as possible. As can be seen, however, regardless of the careful setting of the relative propeller speeds for minimum torque, not only does the magnitude of the mean roll of the body steadily increase but there is an unstable oscillation as well.

While certain embodiments and features of the invention have been illustrated and described herein, many modifications, substitutions, changes, and equivalents will occur to those of ordinary skill in the art. For example, embodiments are disclosed having a plurality of counter-rotating members arranged to control body or vehicle roll about one given axis. Such disclosed embodiments are only for purposes of example.

One alternative embodiment arranges and controls, via feedback control, a first plurality of counter-rotating members (not shown) to obtain a net reactive torque about a first axis, and arranges and controls, via feedback control, a second plurality of counter-rotating members (not shown) to obtain a net reactive torque about a second axis. According to an embodiment, multi-axis feedback stability control is provided. According to one example, a vehicle supports a first plurality of counter-rotating members having respective reaction torques summing to a first net reaction torque, the first net reaction torque being substantially along a first axis, such as a roll axis within the conventional meaning of “roll,” and supports a second plurality of counter-rotating members (not shown) having respective reaction torques summing to a second net reaction torque, the second net reaction torque being substantially along a second axis, such as a yaw axis within the conventional meaning of “yaw.” The second plurality of counter-rotating members may a configuration different than the first plurality of rotating members. For example, the first plurality of rotating members may be arranged as shown in the FIG. 2 example, and may be propellers configured to impart a thrust force and respective reactive torques to a vehicle. The second plurality of counter-rotating members may, for example, extend vertically downward from the vehicle, and may be configured to impart little thrust force, but to exert significant reactive to torques.

According to one embodiment a roll sensor and a yaw sensor detect a roll error and a yaw error. A controller, such as the microcontroller of FIG. 2, performs a feedback control algorithm, based on the roll error and the yaw error, to generate controls (comparable to MC1 and MC2) for a first mechanical power unit to apply individually controllable torque to each of the first plurality of rotating members and, similarly, for a second mechanical power unit to apply individually controllable torque to each of the second plurality of rotating members.

It is therefore to be understood that the appended claims are intended to cover all such modifications and changes as fall within the spirit of the invention.

We hereby claim:

1. A vehicle, comprising:
a vehicle rotation detector, arranged to detect a rotation of the vehicle about a given axis, and to generate a corresponding rotation data;
a control unit, arranged to generate a correction data based on said rotation data;
a first rotary member supported by the vehicle and rotatable with the medium;
a second rotary member supported by the vehicle and rotatable within the medium;
a mechanical power unit arranged to rotate the first rotary member in a first rotating direction, at a first torque, and to concurrently rotate the second rotary member in a second rotating direction opposite the first rotating direction, at a second torque, the first torque and the second torque independently controllable, based on the correction data,
wherein the control unit and the mechanical power unit are arranged such that the difference between the first torque and the second torque exerts a net reactive torque moment to the vehicle, the net reactive torque having a direction and magnitude that urges the vehicle toward a given reference rotation about the given axis.

2. The vehicle of claim 1, wherein at least one of the first rotary member and second rotary member is arranged to exert a propelling force on the vehicle, additional to a reactive torque corresponding to the first torque, when rotated.

3. The vehicle of claim 1, wherein the first rotary member is a first propeller and the second rotary member is a second propeller.

4. The vehicle of claim 3, wherein the first propeller and the second propeller are arranged coaxially.

5. The vehicle of claim 1 wherein the vehicle roll sensor includes a roll position sensor and a roll rate sensor.

6. The vehicle of claim 1 wherein the control unit, and the mechanical power unit are arranged such that the first torque and the second torque have respective magnitudes, and the difference between the first torque and the second torque has a magnitude and a direction exerts a net reactive torque moment to the vehicle having a direction and magnitude that urges the vehicle toward a given reference rotation about the given axis.

7. A body, comprising:
a net torque sensor for detecting a net torque acting on the body;
a controller for generating a torque control signal based on the detected net torque;
a first rotary member supported by the body to rotatably contact an external medium;
a second rotary member supported by the body to rotatably contact the external medium;
a mechanical power unit arranged to rotate the first rotary member in a first rotating direction, at a first torque, and to concurrently rotate the second rotary member in a second rotating direction opposite the first rotating direction, at a second torque, the first torque and the second torque independently controllable based on the torque control data,
wherein the control unit and the mechanical power unit are arranged such that the difference between the first torque and the second torque reduces the detected net reactive torque toward zero.

8. The vehicle of claim 1, wherein the mechanical power unit comprises:
a first mechanical power unit;
a first drive shaft coupling the first mechanical power unit to the first rotary member;
a second mechanical power unit; and
a second drive shaft coupling the second mechanical power unit to the second rotary member.

9. The vehicle of claim 4, wherein the mechanical power unit comprises:
a first motor
a first drive shaft coupling the first motor to the first rotary member;
a second motor; and
a second drive shaft coupling the second motor to the second rotary member,
wherein the first motor includes a hollow motor shaft having a motor shaft through-bore, the first drive shaft is a hollow shaft having a drive shaft through-bore, and the second drive shaft extends through the motor shaft through bore and through the drive shaft through-bore.

10. The vehicle of claim 8 wherein the first motor includes a hollow motor shaft having a motor shaft through-bore, the first drive shaft is a hollow shaft having a drive shaft through-bore, and the second drive shaft extends through the motor shaft through bore and through the drive shaft through-bore.

11. The body of claim 7, wherein the mechanical power unit comprises:
a first mechanical power unit;
a first drive shaft coupling the first mechanical power unit to the first rotary member;
a second mechanical power unit; and
a second drive shaft coupling the second mechanical power unit to the second rotary member.

12. The vehicle of claim 1, wherein the mechanical power unit comprises a motor and a continuously-variable single-input-dual-output transmission having an input coupled to the motor, a first output coupled to the first rotary member and a second output coupled to the second rotary member, wherein the continuously-variable single-input-dual-output transmission is constructed and arranged to rotate the first rotary member in the first rotating direction, at the first torque, and to concurrently rotate the second rotary member in the second rotating direction opposite the first rotating direction, at the second torque, the first torque and the second torque independently controllable, based on the correction data.

13. The body of claim 7, wherein the mechanical power unit comprises a motor and a continuously-variable single-input-dual-output transmission having an input coupled to the motor, a first output coupled to the first rotary member and a second output coupled to the second rotary member, wherein the continuously-variable single-input-dual-output transmission is constructed and arranged to rotate the first rotary member in the first rotating direction, at the first torque, and to concurrently rotate the second rotary member in the second rotating direction opposite the first rotating direction, at the second torque, the first torque and the second torque independently controllable, based on the correction data.
